(19) United States
(12) Patent Application Publication
(10) Pub. No.: US 2009/0323082 A1
(43) Pub. Date: Dec. 31, 2009

(54) Optical Profile Scanning

(75) Inventors: Sandor Matyas Patko, Derbyshire (GB); Peter Daniel Asprey, Derbyshire (GB)

Correspondence Address: Tod T. Tumey, P.O. BOX 22188, HOUSTON, TX, 77227-2188, US

(73) Assignee: DeltaRail Group Limited, Derby, Derbyshire (GB)

(21) Appl. No.: 12/374,981

(22) PCT Filed: Jul. 26, 2007
(86) PCT No.: PCT/GB07/50448

§ 371 Date: Jan. 23, 2009

(30) Foreign Application Priority Data
Jul. 28, 2006 (GB) 0615032.0

(51) Int. Cl. G01B 11/25; E01B 35/06

(52) U.S. Cl. 356/603

(57) ABSTRACT

A profile of a surface of an object (12) that has a longitudinal axis is determined by arranging a camera (14) to view a portion of the surface with its viewing axis (15) substantially perpendicular to the longitudinal axis, and arranging two scanning light sources (16, 18) to define planes of illumination which define two lines on the surface, so that the camera produces an image including images of the two lines. From the separation of the two lines in the image the surface profile can be determined. The planes of illumination are preferably inclined to one another, as this can enhance sensitivity.

This invention relates to an optical method for determining a profile of a surface, and to a profile scanner operating in accordance with this method.

Optical profile scanners such as laser profile scanners are known instruments. They comprise a light source such as a laser that is arranged to scan through an angle to define a plane of illumination, and a camera arranged to view the shape of the line of illumination on an object, such as a wheel of a railway train. From the shape of the line seen by the camera, the shape of the object can be determined. Hitherto the calibration of such devices has required information about the locations of the light source and the camera. The standard known method of operation is to arrange the light source such that the incident plane is perpendicular to a longitudinal axis of the object; the camera is arranged with its viewing axis at a large angle (say in the range 45° to 70°) to the incident plane. Such instruments can provide accurate measurements of the cross-sectional shape of objects such as rails and steel bars, but where this technique is used to monitor the shape of metallic objects which are shiny there are two potential problems: firstly there is a risk of sunlight being reflected towards the camera; secondly the amount of light scattered towards the camera by a shiny surface is a small proportion of the incident light, and consequently the technique requires a high power light source and a sensitive camera, and needs good shielding for safety of any people in the vicinity.

According to the present invention there is provided a method of determining a profile of a surface of an object, the object having a longitudinal axis, the method comprising the steps of arranging a camera to view a portion of the surface with its viewing axis substantially perpendicular to the longitudinal axis of the object, and arranging two light beam sources to define planes of illumination, the planes of illumination intersecting the said portion of the surface to define two lines on the surface, so that the camera produces an image of the portion of the surface including images of the two lines, and from the separation of the two lines in the image at a multiplicity of positions along the lines deducing the surface profile of the object.

Preferably the light beam sources are arranged close to the camera, most preferably with the camera between them. Preferably the light beam sources and the camera are sufficiently close together that the angles between straight lines from a position on the surface to the light beam sources and to the camera are less than 40° and more preferably less than 30°. This has the benefit that the light beam sources and camera can be fixed together and treated as a single unit. A further benefit is that the camera is viewing light scattered in a direction close to that of reflected light, which is somewhat more intense than light scattered at large angles, so this arrangement enhances the intensity of the image.

In one mode of operation the planes of illumination are each parallel to the viewing axis of the camera. In this case the two lines on the surface are parallel, but their separation in the image at different positions along them varies because of any variation in distance from the camera (due to the surface profile), and so the separation of points along the lines in the image may be related to the surface profile. However this does not provide a sensitive measurement method.

In a preferred mode of operation the planes of illumination are inclined to one another. This enables considerably greater sensitivity to be obtained, the separation of the lines in the image varying much more significantly with distance from the camera and so with the profile. The planes of illumination may be arranged to intersect between the camera and the surface, or beyond the surface.

The present invention also provides a profile scanner for determining a profile of a surface of an object, the object having a longitudinal axis, and the profile scanner comprising a camera which may arranged to view a portion of the surface with its viewing axis substantially perpendicular to the longitudinal axis of the object, and two light beam sources which may be arranged to define planes of illumination, the planes of illumination intersecting the said portion of the surface to define two lines on the surface, so that the camera produces an image of the portion of the surface including images of the two lines, and means to deduce, from the separation of the two lines in the image at a multiplicity of positions along the lines, the surface profile of the object.

Preferably the light beam sources are arranged close to the camera, most preferably being mounted together as a unit. They may be enclosed within a common housing provided with an aperture or window.

In this specification the term “longitudinal axis” should not be taken as implying that the object is of exactly uniform cross-section: if it were, then one measurement of its profile would be sufficient. The longitudinal axis is rather an axis that extends in the length direction of the object. The method of the present invention is particularly suited to measurements on objects which do not vary rapidly in their cross-sectional profile, as it will be appreciated that the profile that is deduced is averaged over the distance between the lines on the surface. It is for example suitable for measurements on yacht masts; or on rails on a railway for determining the shape of the railhead, and in this context both the camera and light sources would be arranged so that the viewing axis intersects the railhead from above. Problems from reflected sunlight can easily be avoided, as reflected sunlight would only go vertically upwards from the railhead if the sun were substantially overhead, and in that case the viewed portion of the surface would typically be in the shadow of the camera or of adjacent items. Hence a less intense light source can be used than is required with the conventional laser profile scanner.

It will also be appreciated that calibration of the profile scanner of the invention is straightforward: for example it may be achieved by holding a flat piece of card at different known distances from the camera, and at each distance observing the separation of the two lines in the image. The results from these measurements can be incorporated into a lookup table or used in equations.

The invention will now be further and more particularly described, by way of example only, and with reference to the accompanying drawings in which:

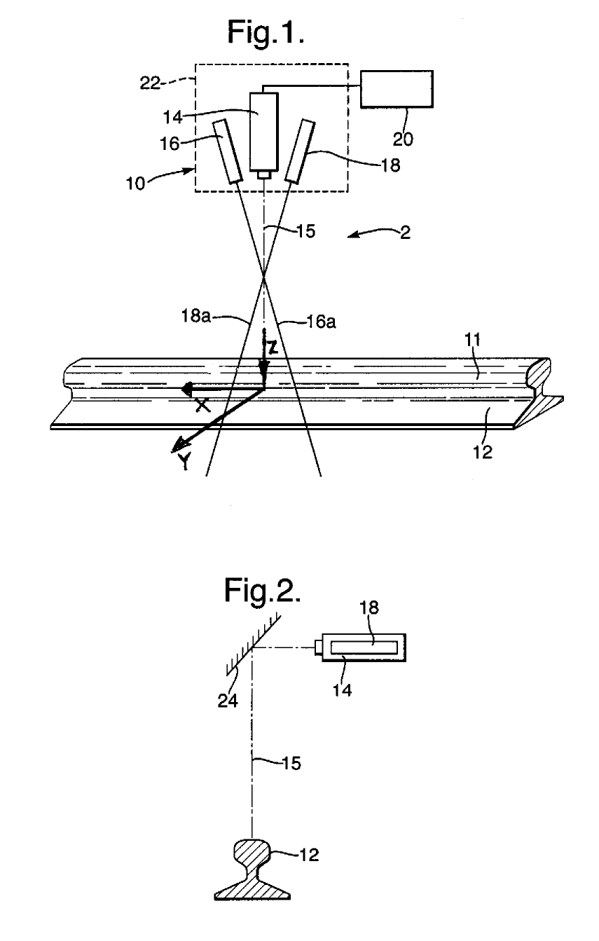

FIG. 1 shows a side view of a laser profile scanner of the invention; and

FIG. 2 shows a view of a modification to the scanner of FIG. 1, in a direction equivalent to that of arrow 2 in FIG. 1.

An optical profile scanner 10 is shown for determining variations in the profile of a railhead 11 of a rail 12. The scanner 10 includes a video camera 14 arranged above the railhead 11 to view the railhead 11 so that its viewing axis 15 (shown as a chain dotted line) is substantially perpendicular to the longitudinal axis of the rail 12. The scanner 10 also includes two scanning light sources 16 and 18 (which would typically be scanning lasers) supported on opposite sides of the camera 14, defining respective planes of illumination 16a and 18a. The light sources 16 and 18 are spaced apart in a direction parallel to the longitudinal axis of the rail 12, and the scanning planes 16a and 18a are tilted respectively forwards and backwards by about 15° relative to a plane perpendicular to the longitudinal axis. The planes of illumination 16a and 18a intersect about halfway between the objective lens of the camera 14 and the railhead 11, so that they diverge in the vicinity of the railhead 11. The laser scans to and fro so as to define the plane, which would give a straight line if it were incident on a flat surface. The image from the camera 14 is supplied to an image-processing computer 20. For several different positions across the width of the rail 12 the computer 20 determines the longitudinal separation of the corresponding lines in the image. That longitudinal separation depends only on the distance of that part of the railhead 11 from the camera 14, so that the computer 20 can hence determine the variation in height of the railhead 11 across the width of the rail 12, that is to say its profile.

Each point in the reconstructed profile is given by two coordinates, Z and Y. The distance from the camera, Z, is the first coordinate, and this is the distance measured parallel to the optical axis of the camera (not radially from the camera). The calibration process (described below) enables this distance to be determined for all positions in the image. The value of Z is obtained from a measurement of the distance apart of the lines, in a direction parallel to the longitudinal axis X, at a particular position in the image. The other coordinate, Y, represents the distance laterally away from the longitudinal axis X. Once the value of Z has been ascertained for a particular position in the image, the corresponding value of Y can be deduced by mathematically reversing the imaging process from the position on the image (at which the separation was measured), to deduce the corresponding distance Y from the axis at the distance Z. Hence the profile can be deduced across the width of the railhead 11.

In a modification, the scanning light sources 16 and 18 are replaced by means to generate and project a plane of light, for example using line-generating optics.

The scanner 10 may be calibrated by holding a flat surface such as a white card at various different distances away from the camera 14 (that is to say at various different heights), so that the planes of illumination 16a and 18a form straight lines on the card, and for each position of the card determining the separation of the corresponding lines in the image. The relationship between line separation and distance is geometrically defined. If, due to optical distortions, the images of the straight lines are not themselves straight, then the calibration relationship will be slightly different at different positions across the width of the object. In any event, the calibration process can be used to generate a look-up table to establish the actual relationship, for example, or to represent the relationship graphically, or by means of an equation (such as a polynomial).

It will be appreciated that the scanner 10 may be modified in several different ways while remaining within the scope of the present invention. It will be appreciated that instead of a video camera the scanner might incorporate a film camera, the subsequent image analysis being carried out after the film has been developed. Because the light sources 16 and 18 are mounted close to the camera 14 the scanner is a comparatively compact instrument, and indeed the light sources 16 and 18 and the camera 14 might be enclosed within a common housing 22 (shown in broken lines) provided with apertures or windows for the camera 14 and light sources 16 and 18.

The scanner 10 may be installed underneath a railway vehicle (not shown) so that it can readily be scanned along the length of the rail 10 to monitor any variations in its profile. In a modification, as shown in FIG. 2 to which reference is now made, the camera 14 is set up in a generally horizontal plane with the light sources 16 and 18 (only the latter is shown in FIG. 2) scanning above and below that horizontal plane, and a mirror 24 is arranged to ensure that the camera 14 views the railhead 11 from above. This arrangement may enable the total height of the scanner 10 to be reduced, and may enable the scanner 10 to be mounted into a restricted space.

What is claimed:

1. A method of determining a profile of a surface of an object, the object having a longitudinal axis and the profile being perpendicular to the longitudinal axis, the method comprising the steps of arranging a camera to view a portion of the surface with its viewing axis substantially perpendicular to the longitudinal axis of the object, and arranging two light beam sources to define planes of illumination, the planes of illumination intersecting the said portion of the surface to define two lines on the surface, operating the camera to produce an image of the portion of the surface including images of the two lines, wherein the method also comprises determining the longitudinal separation of the two lines in the image at a multiplicity of positions along the lines across the object, and determining therefrom the surface profile of the object.

2. A method as claimed in claim 1 wherein the light beam sources are arranged close to the camera, with the camera between them.

3. A method as claimed in claim 2 wherein the light beam sources and the camera are sufficiently close together that the angles between straight lines from a position on the surface to the light beam sources and to the camera are less than 40° and more preferably less than 30°.

4. A method as claimed in claim 1 wherein the planes of illumination are each parallel to the viewing axis of the camera.

5. A method as claimed in claim 1 wherein the planes of illumination are inclined to one another.

6. A method as claimed in claim 5 wherein the planes of illumination are arranged to intersect between the camera and the surface.

7. A profile scanner for determining a profile of a surface of an object, the object having a longitudinal axis, and the profile scanner comprising a camera which may be arranged to view a portion of the surface with its viewing axis substantially perpendicular to the longitudinal axis of the object, and two light beam sources which may be arranged to define planes of illumination, the planes of illumination intersecting the said portion of the surface to define two lines on the surface, so that in operation the camera produces an image of the portion of the surface including images of the two lines, wherein the scanner also comprises means for determining the surface profile of the object from the separation of the two lines in the image at a multiplicity of positions along the two lines.

8. A profile scanner as claimed in claim 7 wherein the light beam sources are arranged close to the camera, and are mounted together as a unit.

9. A profile scanner as claimed in claim 8 wherein the light beam sources and the camera are enclosed within a common housing.

10. A profile scanner as claimed in claim 7 incorporating a reflection means to ensure that the camera views the object along a desired viewing axis.

11. (canceled)

12. (canceled)
